(19) United States
(12) Patent Application Publication
(10) Pub. No.: US 2010/0167074 A1
(43) Pub. Date: Jul. 1, 2010

(54) ADHESIVE FOR DIFFICULT TO ADHERE POLYMER COATED BOARD STOCK

(76) Inventors: William L. Bunnelle, Ham Lake, MN (US); Keith A. Knutson, Saint Paul, MN (US)

Correspondence Address: PAULY, DEVRIES SMITH & DEFFNER, L.L.C., Plaza VII-Suite 3000, 45 South Seventh Street, MINNEAPOLIS, MN, 55402-1630, US

(21) Appl. No.: 12/346,366

(22) Filed: Dec. 30, 2008

(51) Int. Cl. B32B 23/08; C09J 109/00

(52) U.S. Cl. 428/512; 524/271

(57) ABSTRACT

Adhesives are uniquely formulated to ensure appropriate adhesion to polymer coated paperboard. Such adhesives can be used in case and carton sealing applications and other applications using the coated paperboard stock material. The coatings can often pose problems for adhesives designed to adhere to the coated surfaces. The adhesives of the invention form adequate adhesive bonds to the coated corrugated paperboard such that the paperboard can be adhered to other substrates or to itself in case and carton sealing purposes. Coated paper board or coated corrugated board stock is commonly used in packaging materials where the package is exposed to extremes of temperature, humidity or liquid moisture. The coatings are used in packaging materials to withstand sufficient amounts of moisture such that the strength of either the adhesive used in the manufacture of the paperboard or the cellulosic base material of the paperboard are not compromised. The coatings on the paperboard or corrugated board stock impede penetration of moisture into the paperboard materials.

### FIELD OF THE INVENTION

The invention is related to adhesives uniquely formulated to ensure appropriate adhesion to the surface of polymer coated paperboard. Coated paper board or coated corrugated board stock is commonly used in packaging materials and in certain applications where the package is exposed to extremes of low temperature, humidity or liquid moisture. The coatings on the paperboard or corrugated board stock impede penetration of moisture into the paperboard materials, but can often pose problems for adhesives designed to adhere to the coated surfaces.

### BACKGROUND OF THE INVENTION

Paperboard containers and multi-ply corrugated paperboard containers are shown in (e.g.) U.S. Pat. Nos. 1,157,406, 1,197,324, 3,450,327 and 3,603,218. In the past, containers made of paperboard or corrugated paperboard stock, have, for many years been coated with wax or wax-like materials to render the paperboard increasingly resistant to water over a range of temperatures. Such materials are suitable for containing food stuffs having substantial liquid content or for containing frozen foods. Such containers have an amount of wax applied to the interior and/or exterior walls of the paperboard container or to the corrugated paperboard. When used such paperboard or corrugated paperboard containers must be sealed in order to maintain the contents in a safe unspoiled condition. Further, and in certain applications, the coated surface of paperboard or coated corrugated paperboard materials are often adhered to other coated or uncoated substrates to form different packaging assemblies or are contacted and adhesively bonded to labels and other sheet-like materials. Recently both the availability and cost of waxes for the purpose of making coated paperboard have become problematic. Insufficient amounts of wax are now available for coating requirements in the paperboard industry and even if the wax is available, the wax has substantial costs associated with its acquisition.

Recently polymer coated boards have been developed. A variety of polymer coatings are now in use and UV and acrylic varnished or grease resistant treated boards are conventionally used in the consumer packaging applications. Varnishing, for example, is conventionally used to improve the aesthetic appeal of the e.g., box, carton, container or the like. Substrates, such as paper, paperboard, and cardboard, used to make containers for the distribution and storage of food products are commonly treated with a polymer agent or coating that makes the paper stain or leak-proof. A stain or leak-proof barrier is required for paper that comes into contact with oily, greasy or watery food. Such treatment prevents wicking or staining that occurs on non-treated papers with high grease or high fat content products, such as for example, pet foods. Treatments that provide a barrier to moisture or air are also commonly used in the packaging industry. Fluorine-containing chemicals and copolymers, collectively referred to as fluorochemicals, have been used for a number of years to impart water, oil and grease resistance to substrates such as paper.

Hot melt adhesives are widely used for various commercial applications such as product assembly and packaging, including cardboard case sealing and carton closing operations. Such hot melt adhesives are applied to a substrate in a molten state and subsequently cool to harden the adhesive layer. The presence of varnish, grease resistant coatings and the like, however, make the substrates difficult to bond together—e.g. surface energy can go down to about 25 dyn/cm. Such coated or treated substrates become resistant to conventional hot melt adhesives applied for the purpose of bonding paper to paper closures. In order to solve these issues, packaging converters must produce unvarnished or untreated areas on treated or coated boards or boards treated for grease resistance. Considerable costs are incurred in terms of production efficiency (e.g., setting time of the printing machine, removal of the blanks, drying hours and storage space), as well as increased packaging costs to the industrial user. Paper to paper bonding with good shear, peel and tearing properties of such containers is of considerable industrial importance and consequently there is a great deal of work done in this area of technology. For example, U.S. Pat. No. 3,313,218 describes a method for joining waxed paperboard surfaces whereby glue is heated to an extremely high temperature before application to the waxed surface. In this method, the super-heated glue melts the wax, allowing for adhesion of the two waxed surfaces. In other prior art methods, a clay coat is used for improvement of adhesion of grease resistant surfaces. U.S. Pat. No. 4,609,571 discloses the use of a primer formulation comprising styrene/butadiene rubber to promote hot melt adhesion of fluorocarbon treated grease resistant papers. See also, US 200391760 A1 teaching adhesives for difficult to adhere substrates.

Even more recently, newly designed coated or laminated paperboard has been manufactured that obtains a polymer coating or laminated sheet on the interior or exterior side of the paperboard or corrugated paperboard. The coatings or lamination can comprise a variety of polymer materials. Broad categories of synthetic coating are used including waxes; polyester coatings; SBC Styrene Block Copolymer materials, including styrene-butadiene (SB); acrylates (Acryl); ethylene vinyl-acetate (EVAc); Polyvinyl alcohol and ethylene vinyl alcohol polymers (EVOH and PVOH) polymers. Examples of suitable synthetic materials are water dispersible and include, for example, polyvinyl pyrrolidone, polyethylene glycol, polyvinyl alcohol, polyvinylmethyl ether, polyacrylic acids, polyacrylic acid salts, polyvinyl acrylic acids, polyvinyl acrylic acid salts, polyacrylimides, ethylene oxide polymers, polylactic acid, and latex dispersions (which is a broad category that includes a variety of polymerizable substances formed in a water emulsion; an example is styrene-butadiene copolymer).

Polymer coating selection depends on the coated paperboard end use application and is sometimes specified by the paperboard end user. The water-dispersible polymers within the moldable mixtures of the present invention are preferably included in an amount such that a hardened sheet manufactured therefrom will contain from about 1% to about 50% organic by volume of the total solids within the hardened sheet, more preferably from about 2% to about 30%, and most preferably from about 5% to about 20%.

One aspect of such advance materials include a polyester coated paperboard. Such coatings are made by applying an aqueous coating suspension or solution to the stock surface. Such materials are made from commonly available Kraft paper or paperboard stocks in the form of single layer paperboard or corrugated paperboard structures. These structures can be coated with polyesters. Typical polyesters include polyethylene terephthalate, polyethylene naphthalate, polyhydroxy burate, polylactic acid, and other similar synthetic or naturally derived polyester materials. One problem that has arisen from the use of the newer polyester coated paperboards is that adhesives formulated for wax adhesion or other difficult to adhere surfaces no longer appear to be satisfactorily bonded using the adhesives formulated for wax adhesion.

A substantial need exists in the packaging industry for adhesive formulations that can adequately adhere to polymer coated paperboard or corrugated paperboard and can successfully be used as case or carton sealing adhesives or to adhere labels or other structures to the coated surfaces of the paperboard.

### BRIEF DESCRIPTION OF THE INVENTION

The invention resides in an adhesive bonded assembly and in an adhesive used in forming the assembly. The assembly of the invention comprises at least one layer comprising a polymer coated paperboard material, a substrate bonded to the paperboard using an adhesive bond to join the coated paperboard and the substrate. We have found an adhesive, that comprises an effective amount of a styrene block copolymer, an ethylene vinylacetate polymer, an appropriate compatible tackifying resin and a natural wax or oil, can form a strong adhesive bond that can be used either in case and carton sealing or for bonding a substrate to a polymer or polyester coated layer. More importantly, not only do these adhesives bond the substrates at room temperature, the adhesives of the invention bond these substrates at low freezer temperatures often as low as −20 to −30° C. (−10 to −20° F.). Both wax coated board stock, acrylic coatings and newer polymer or polyester coated board stock, even when primarily used in wet and cold environments, are adequately bonded with the adhesives of the invention. As used herein, “paperboard” refers to a web of cellulosic fibers in sheet form. The paperboard used in preferred embodiments generally may be any paperboard suitable for folding cartons or corrugated board or as a substrate for laminating to a backing such as gypsum board. The term paperboard includes paper and paperboard of different thicknesses.

### DETAILED DESCRIPTION OF THE PREFERRED EMBODIMENT

The adhesive of the invention combines a SBC polymer, an ethylene based copolymer a compatible tackifier and a wax or oil. Preferred adhesives comprise a SBS copolymer and ethylene vinyl acetate copolymer a rosin ester tackifier and a specific wax. The paper described herein may be shaped, processed or incorporated into semi-finished or finished manufactured items such containers (e.g., paper bags, paper boxes, cardboard boxes, mailing tubes, file folders), cardboard, corrugated cardboard, honeycomb paperboard structures (e.g., cellular structures having open or closed cells of one or more shapes, including without limitation hexagonal, polygonal, and/or rounded shapes), and packaging material, by processes and methods generally known to those skilled in the art. The paperboard materials contain at least one layer of a polymer layer or coating. The coatings can be made in any of the conventional methods including coatings that are typically applied by aqueous coating techniques and are about 0.001 to less than 1 mm in thickness.

Examples of biodegradable coating polymers include, but are not limited to, modified polyethylene terephthalates, polylactic acid (PLA), higher melting polyesteramides, PLA/PGA/PCL terpolymers, and higher melting grades of polyhydroxy buterate-valerate or polyhydroxy buterate (PHBV or PHB). Non-biodegradable polymers include higher melting polyolefin and polystyrene. Examples of biodegradable coating polymers include branched aliphatic-aromatic copolyesters and linear aliphatic-aromatic copolyesters. Other biopolymers include, but are not limited to, polycaprolactone (PCL), lower melting polyesteramides, aliphatic polyesters and lower melting polyester carbonates.

An adhesive used to bond to the polymer coating can comprises a hot melt adhesive comprising an effective amount of a styrene block copolymer, an ethylene based copolymer preferably an ethylene vinylacetate copolymer, an appropriate compatible tackifying resin and a natural wax or oil. Such a hot melt formulation can form a strong adhesive bond that can be used either in case and carton sealing or for bonding a substrate to a polyester coated layer.

A thermoplastic hot melt adhesive composition comprising a thermoplastic ethylene vinyl acetate (EVA) material. Such adhesives can be prepared in combination with appropriate additive materials. The polymer has a melt index greater than about 100 grams-10 min⁻¹, often greater than 400 grams-10 min⁻¹, or about 800 grams-10 min⁻¹ to 2500 grams-10 min⁻¹ The polymer preferably has a comonomer content, e.g., a vinyl acetate content of between 14 wt % to 30 wt % vinyl acetate in the copolymer. The balance of the copolymer typically comprises the ethylene monomer. An example of useful material typically is centered on an ethylene vinyl acetate polymer containing about 20±5 wt % vinyl acetate copolymer or an ethylene vinyl acetate material comprising about 27±5 wt % vinyl acetate comonomer. The polymer material used in the invention can be derived from a single polymeric raw material or source material or can be a blend of two or more polymer materials or source materials obtained from raw material manufacturers. The weight ratio of a second polymeric material to the first polymeric material used in the preparation of the adhesives of the invention can range from about 0.01 to about 10 parts by weight of the second polymeric material per each part by weight of the first polymeric material.

The adhesive can use about 10 to 30 wt. % of a block polymer to increase cohesive strength in the adhesive and increase peal strength after application. Block polymers useful include ABA structures, AB structures, (A-B)n radial polymers, as well as branched and grafted materials. The B block is typically isoprene, butadiene, hydrogenated butadiene, hydrogenated isoprene, etc. Commercial embodiments include the Kraton® block polymer materials, (Shell Chemical Company, Houston, Tex.), Septon® (SEEPS) materials for Kuraray Co., Ltd., Europrene® block polymer materials, Sol T polymer materials (EniChem, Houston, Tex.), Vector® block polymer materials (Exxon/Dexco, Houston, Tex.). The A block (styrene or vinyl) content of the polymer ranges from 0.1 wt-% to about 50 wt-%. Typically, the aromatic A block concentration ranges from about 5 wt-% to about 45 wt-% based on the polymer. The styrene content can be less than about 25 wt-%, more preferably less than about 20 wt-% and most preferably from about 5 wt-% to about 15 wt-% styrene with respect to the total weight of the block copolymer for certain formulations. When employed with a ethylene/α-olefin polymer having a relatively high melt index, preferably the block copolymer comprises a hydrogenated block copolymer. For this embodiment the block copolymer contributes significantly to the cohesive strength of the adhesive composition. The molecular weight of a block copolymer relates to its solution viscosity at 25° C., for a given weight of polymer in (toluene) solvent. The amount of block copolymer employed for determining the solution viscosity depends on the molecular weight. For the higher molecular weight block copolymers, the solution viscosity is typically expressed as a function of a 10 wt-% or 15 wt-% block copolymer solution, whereas for more conventional and lower molecular weight block copolymers, a 25 wt-% block copolymer solution is employed. For 10 wt-% or 15 wt-%, the solution viscosity of the block copolymer for use in the invention ranges from about 100 cP to about 3·10³ cP at about 25° C. For a 25 wt-% block copolymer solution, the solution viscosity may range from about 10² to about 10⁵ cP, preferably from about 100 to about 8·10⁴ cP, more preferably from about 200 to about 3·10⁴ and most preferably from about 200 to about 2·10⁵ cP. For low viscosity adhesive compositions, preferably the solution viscosity of the block copolymer employed is less than 10·10³ cP, more preferably less than about 5·10⁻³, even more preferably less than about 2.5·10³ cP and most preferably less than about 2·10³ cP. The block polymer is substantially hydrogenated in which the midblock is typically ethylene/butylene, ethylene/propylene, or mixtures thereof. Preferred block copolymers comprise substantially saturated materials having styrene endblocks and ethylene/butylene or ethylene/propylene midblocks and having a di-block content of less than about 70%, a di-block content of preferably less than about 50% and more preferably less than about 30%. The block copolymers useful herein preferably have a melt index of greater than about 20 grams/10 minutes, more preferably greater than about 30 g/10 min, even more preferably greater than about 50 g/10 min. and most preferably greater than about 60 g/10 min. The styrene content is preferably from about 10% to about 40% by weight of the block copolymer, more preferably from about 10% to about 35% by weight and most preferably from about 10% to about 30% by weight of the block copolymer. Other preferred Styrene-ethylene/propylene-styrene (hereinafter SEEPS) block copolymers are available from Kuraray Company, Ltd in Tokyo, Japan under the tradename of Septon® and may also be utilized providing the block copolymer meets the diblock requirement. These block copolymers are useful from about 5 wt-% to about 30 wt-% of the adhesive. Kraton® G-1650, a linear styrene-ethylene/butylene-styrene block copolymer having a diblock content of 0%, an M.sub.N of about 113,000 and a styrene content of about 28%; and Septon®4033 supplied by Kuraray, Japan, a linear styrene-ethylene/propylene-styrene block copolymer having a diblock content of 0%, an Mₙ of about 108,000 and a styrene content of about 30% by weight of the copolymer. The midblocks are preferably ethylene/butylene, ethylene/propylene or isoprene and are more preferably ethylene/butylene or ethylene/propylene. The styrene content is preferably between about 10% and about 40% by weight of the block copolymer, more preferably from about 10% to about 35% by weight, even more preferably from about 10% to about 30% by weight and most preferably from about 10% to about 25% by weight. The melt index of these block copolymers is preferably greater than about 5 g/10 min. and more preferably greater than about 10 g/10 min. Useful examples include Kraton®1652 available from Shell Chemical Co., a 100% linear SEBS block copolymer having about 29% styrene and a melt index of about 10 g/10 min. These block copolymers are useful from about 5 wt-% to about 50 wt-% of the adhesive, preferably from about 10 wt-% to about 50 wt-% of the adhesive and more preferably from about 10 wt-% to about 40 wt-% of the adhesive. The composition of the present invention is preferably made by first preparing the thermoplastic component by melting and blending all the thermoplastic ingredients. The thermoplastic composition may be pelletized, pillowed, or cast into molds or drums, etc., for subsequent remelting and application. Alternatively, all the ingredients may be fed simultaneously at the appropriate rates into an extruder. Preferred thermoplastic polymers for use in the compositions of this invention are ethylene-vinyl-acetate (EVA) and a styrene-butadiene-styrene (SBS) block copolymer.

The tackifying resins which are used in the hot melt construction adhesives of the present invention are those which extend the adhesive properties and improve the specific adhesion of the polymer. As used herein, the term “tackifying resin” includes natural and modified rosin such as, for example, gum rosin, wood rosin, tall-oil rosin, distilled rosin, hydrogenated rosin, dimerized rosin and polymerized rosin; glycerol and pentaerythritol esters of natural and modified rosins, such as, for example, the glycerol ester of pale wood rosin, the glycerol ester of hydrogenated rosin, the glycerol ester of polymerized rosin, the pentaerythritol ester of pale wood rosin, the pentaerythritol ester of hydrogenated rosin, the pentaerythritol ester of tall oil rosin and the phenolic modified pentaerythritol ester of rosin; polyterpene resins having a softening point, as determined by ASTM method E28-58T, of from about 20° C. to 140° C., the latter polyterpene resins generally resulting from the polymerization of terpene hydrocarbons, such as the monoterpene known as pinene, in the presence of Friedel-Crafts catalysts at moderately low temperatures; also included are the hydrogenated polyterpene resins; copolymers and terpolymers of natural terpenes, e.g. styrene/terpene, &#945;-methyl styrene/terpene and vinyl toluene/terpene; phenolic-modified terpene resins such as, for example, the resin product resulting from the condensation, in an acidic medium, of a terpene and a phenol; aliphatic petroleum hydrocarbon resins having Ring and Ball softening points of from about 10° C. to 140° C., the latter resins resulting from the polymerization of monomers consisting primarily of olefins and diolefins; also included are the hydrogenated aliphatic petroleum hydrocarbon resins; examples of such commercially available resins based on a C 5-olefin fraction of this type are “Wingtack 95” and “Wingtack 115” tackifying resins sold by Goodyear Tire and Rubber Company; aromatic petroleum hydrocarbons and the hydrogenated derivatives thereof; aliphatic/aromatic petroleum derived hydrocarbons and the hydrogenated derivatives thereof. Mixtures of two or more of the above described tackifying resins may be required for some formulations. Although a range of 20-70% by weight tackifying resin may be used, the preferred range is 35% to 60% and the most preferred range is 45% to 60%. An example of a commercially available tackifying resin which is useful for the present invention includes the resin which is identified commercially by the trade designation Unitac RI OOL. This resin is a pentaerythritol based tall-oil rosin ester, and is available from Union Camp.

Commercially available polymerized rosins may be secured from Arizona Chemical Company under the trade designations “Sylvatac 295, RX, R85, 95, and 140,” respectively. Additionally, Hercules, Inc. produces a suitable dimerized rosin under the trade designation “Dymerex.” Commercially suitable partially hydrogenated rosins may be secured from Hercules, Inc. under the trade designations “Foral AX” and “Stabelite.” Finally, partial ester of dibasic modified tall oil rosins may be secured from Arizona Chemical Company under the trade designation “Sylvatac 203,” and “Beckacite 4901.”

Waxes or oils in the composition of the present invention can be present either alone or in any desired blend in amounts of about 0% to about 50% by weight, preferably from about 5% to about 40% by weight, and most preferably from about 10% to about 30% by weight, and are used to reduce the melt viscosity and surface tack of the hot melt construction adhesives without appreciably decreasing their adhesive bonding characteristics. These waxes also are used to reduce the open time of the composition without affecting the temperature performance. Among the useful waxes are: low molecular weight, that is, 600-6000 ( M̅n̅), polyethylene having a hardness value, as determined by ASTM method D-1321, of from about 0.1 to 120 and ASTM softening points of from about 150° to 250° F.;(2) petroleum waxes such as paraffin wax having a melting point of from about 130° to 170° F. and microcrystalline wax having a melting point of from about 135° to 200° F., the latter melting points being determined by ASTM method D127-60; atactic polypropylene having a Ring and Ball softening point of from about 120° to 160° C.; synthetic waxes made by polymerizing carbon monoxide and hydrogen such as Fischer-Tropsch wax; and polyolefin waxes. As used herein, the term “polyolefin wax” refers to those polymeric or long-chain entities comprised of olefinic monomer units. These materials are commercially available from Eastman Chemical Co. under the trade name “Epolene.” The materials which are preferred to use in the compositions of the present invention have a Ring and Ball softening point of 200° F. to 350° F. Other useful substances include hydrogenated animal, fish and vegetable fats and oils such as hydrogenated tallow, lard, soya oil, cottonseed oil, castor oil, menhadin oil, cod liver oil, etc., and which are solid at ambient temperature by virtue of their being hydrogenated, have also been found to be useful with respect to functioning as a wax diluent equivalent. These hydrogenated materials are often referred to in the adhesives industry as “animal or vegetable waxes.” Various plasticizing or extending oils may also by present in the composition in amounts of 5% to about 30%, preferably 5 to 25%, by weight in order to provide wetting action and/or viscosity control. Even higher levels may be used in cases where block copolymer containing hydrogenated mid-block are employed as the adhesive base polymer. The above broadly includes not only the usual plasticizing oils but also contemplates the use of olefin oligomers and low molecular weight polymers as well as vegetable and animal oil and their derivatives. The petroleum derived oils which may be employed are relatively high boiling materials containing only a minor proportion of aromatic hydrocarbons (preferably less than 30% and, more particularly, less than 15% by weight of the oil). Alternatively, the oil may be totally non-aromatic. The oligomers may be polypropylenes, polybutenes, hydrogenated polyisoprene, hydrogenated polybutadiene, or the like having average molecular weights between about 350 and about 10,000. Vegetable and animal oils include glycerol esters of the usual fatty acids and polymerization products thereof.

Depending on the contemplated end uses of the adhesives, other additives such as plasticizers, pigments and dyestuffs conventionally added to hot melt adhesives may be included. In addition, small amounts of additional tackifiers and/or waxes such as microcrystalline waxes, hydrogenated castor oil and vinyl acetate modified synthetic waxes may also be incorporated in minor amounts, i.e., up to about 10 weight percent by weight, into the formulations of the present invention. Additionally, hydrocarbon oils, especially naphthenic or paraffinic process oils, may also be employed herein as the wax diluent.

The present invention includes a stabilizer or antioxidant in an amount of from about 0.1% to about 5% by weight, but preferably from about 0.1% to about 3%, and most preferably about 0.1% to 2%. The stabilizers which are useful in the hot melt adhesive compositions of the present invention are incorporated to help protect the polymers noted above, and thereby the total adhesive system, from the effects of thermal and oxidative degradation which normally occurs during the manufacture and application of the adhesive as well as in the ordinary exposure of the final product to the ambient environment. Such degradation is usually manifested by a deterioration in the appearance, physical properties and performance characteristics of the adhesive. A particularly preferred antioxidant is Irganox 1010, a tetrakis(methylene(3,5-di-teri-butyl-4-hydroxyhydrocinnamate))methane manufactured by Ciba-Geigy. Among the applicable stabilizers are high molecular weight hindered phenols and multifunctional phenols, such as sulfur and phosphorus-containing phenols. Hindered phenols are well known to those skilled in the art and may be characterized as phenolic compounds which also contain sterically bulky radicals in close proximity to the phenolic hydroxyl group thereof. In particular, tertiary butyl groups generally are substituted onto the benzene ring in at least one of the ortho positions relative to the phenolic hydroxyl group. The presence of these sterically bulky substituted radicals in the vicinity of the hydroxyl group serves to retard its stretching frequency and correspondingly, its reactivity; this steric hindrance thus providing the phenolic compound with its stabilizing properties. Representative hindered phenols include: 1,3,5-trimethyl-2,4,6-tris(3-5-di-tert-butyl-4-hydroxybenzyl)benzene; pentaerythritol tetrakis-3(3,5-di-tert-butyl-4-hydroxyphenyl)propionate; n-octadecyl-3(3,5-ditert-butyl-4-hydroxyphenyl)propionate; 4,4′-methylenebis(4-methyl-6-tert butylphenol); 4,4′-thiobis(6-tert-butyl-o-cresol);2,6-di-tert-butylphenol;6-(4-hydroxyphenoxy)-2,4-bis(n-ocytlthio)-1,3,5-triazine; 2,4,6-tris(4-hydroxy-3,5-di-tert-butyl-phenoxy)-1,3,5-triazine; di-n-octadecyl-3,5-di-tert-butyl-4-hydroxybenzylphosphonate; 2-(n-octylthio)ethyl-3,5-di-tert-butyl-4-hydroxybenzoate; and sorbitol hexa-(3,3,5-di-tert-butyl-4-hydroxy-phenyl)propionate.

The performance of these stabilizers may be further enhanced by utilizing, in conjunction therewith: (1) synergists such as, for example, thiodipropionate esters and phosphites; and (2) chelating agents and metal deactivators as, for example, ethylenediaminetetraacetic acid, salts thereof, and disalicylalpropylenediimine. The hot melt adhesives of the invention are made in common hot melt manufacturing equipment. In the manufacture of the hot melt adhesives of the invention, the EVA and SBC copolymers typically added to a melt comprising either the tackifier or the wax material or mixtures thereof. Such additions facilitate the blending of the copolymer into a smooth, uniform mixture. In such a manufacturing regimen, either the tackifier or the wax or a portion thereof is added to the manufacturing equipment under inert atmosphere and is heated and agitated until melted. The copolymer is then added to the melt at a rate such that the mixture forms a uniform smooth blend within a reasonable period. Antioxidant materials used in the manufacture of the adhesive can be added to the melt prior to, with, or after the addition of the block copolymer. Once a smooth blend of the copolymer in conjunction with an adhesive component is formed, the balance of the components of the hot melt adhesives can be added at a convenient rate. Once the uniform blend of all the adhesive ingredients is formed, the adhesive can be drawn off and packaged in a convenient form including in drums, blocks, pillows, pellets, granules, etc.

The following examples provide additional information with respect to the manufacture of the adhesives of the invention and include the best mode. Following the standard laboratory blending procedures the following compositions were blended into a hot melt adhesive:

TABLE 1
Bond formation with Comparative materials and
Adhesive of the Invention

| | Example Number | | | | | | | | |
|---|---|---|---|---|---|---|---|---|---|
| | 1 | 2 | 3 | 4 | 5 | 6 | 7 | 8 | 9 |
| Tackifier | | | | | | | | | |
| Sylvalite RE-100L | 47 | | 40 | 40 | 40 | 40 | 26 | 45 | 39.5 |
| Sylvalite RE-85L | | 60 | | | | | | | |
| Wingtack Plus | | | | | | | 26 | | |
| Nyplast 222B | 3 | 5 | | | | | 20 | 19.5 | 10 |
| Ethylene Vinylacetate | | | | | | | | | |
| AC-400 | | 9.5 | | | | | | | |
| AC-629 | | | 19.5 | | 19.5 | | | | |
| AC-5120 | | | | 19.5 | | 19.5 | | | |
| Ethylene/ | | | | | | | | | |
| Acrylic | | | | | | | | | |
| ENBA 33-900 | | | | | 40 | 40 | | | |
| Ethylene/Acrylic | | | | | | | | | |
| Acid/Carbonoxide | | | | | | | | | |
| Elvaloy HP-771 | | | 40 | 40 | | | | | |
| Ethylene Vinylacetate | | | | | | | | | |
| EVA-28-800 | 49.5 | | | | | | | | |
| EVA-28-400 | | | | | | | | | 12 |
| Styrene Block | | | | | | | | | |
| Copolymer | | | | | | | | | |
| Kraton D-1118 | | 25 | | | | | 5 | | |
| Kraton D-1102 | | | | | | | | | 24 |
| Globalprene 3520 | | | | | | | | 35 | |
| Kraton 1119 | | | | | | | 23 | | |
| Nat 155 | | | | | | | | | 14 |
| Antioxident | | | | | | | | | |
| Benox 1010 | 0.5 | 0.5 | 0.5 | 0.5 | 0.5 | 0.5 | 0.5 | 0.5 | 0.5 |
| Bonds @ RT | NFT | NFT | NFT | NFT | NFT | NFT | NFT | NFT | FFT |
| Bonds @ 40° F. | NFT | NFT | NFT | NFT | NFT | NFT | NFT | NFT | FFT |
| Bonds @ −10° F. | NFT | NFT | NFT | NFT | NFT | NFT | NFT | NFT | FFT |

Example 1 is a carton sealing adhesive formulation typical of adhesives in the art for use on wax coated cartons. Example 2 is a formulation which contains the same or similar ingredients as Example 9 but doesn't work because the resin content is too high.

Examples 3, 4, 5 and 6 are examples of adhesives with higher overall polarity that do not achieve needed bonding adhesion to the polymer coated board. Example 7 is a SIS based PSA typical of what would be used for labeling plastic milk containers. Example 8 is a SBS based PSA used for freezer grade labeling applications. None of these materials achieve the binding needed in this application. Example 9 having the SBC, the ethylene copolymer and the compatible tackifier only has the needed bonding characteristics and represents a product of the claimed invention.

TABLE 3
Bond formation with Comparative materials and
Adhesive of the Invention

| Raw Material | Type | 13 | 14 | 15 | 16 | 17 |
|---|---|---|---|---|---|---|
| Norsolene A-110 | Tackifier | 20 | | | | |
| Sylvalite Re-100 | Tackifier | 15 | 35 | 45 | 50 | 40 |
| EVA-33-43 | EVA | 30 | | | | |
| EVA-28-400 | EVA | | 40 | | | |
| EVA-20-2500 | EVA | | | | 50 | |
| AC-405T | EVA | | 25 | | | |
| AC-400 | EVA | | | | | 16 |
| Lotryl EH-550 | Ethylene 2 | | | 30 | | |
| | ethyl-hexyl | | | | | |
| | acrylate | | | | | |
| 155 Paraffin | Paraffin | 35 | | | | |
| Natwax 155 | Hydrogenated | | | | | 24 |
| | Soywax | | | | | |
| Paraflint C-80 | Fischer T | | | 10 | | |
| Nyplast 222B | Napthenic oil | | | 7.5 | | |
| Kraton G-1652 | SEBS | | | 7.5 | | |
| Vector 8508 | SBS | | | | | 20 |
| Bonds @ Room | | FFT | FFT | FFT | FFT | FFT |
| Temp. | | | | | | |
| Bonds @ 40° F. | | 0 | 0 | 0 | 0 | FFT |
| Bonds @ 0° F. | | 0 | 0 | 0 | 0 | FFT |
| Brookfield | | 910 | 1480 | 1250 | 1300 | 1300 |
| Viscosity @ | | | | | | |
| 350 F. | | | | | | |

Example 13 is a general purpose low conventional cost case and carton sealing adhesive which usually adheres well to most substrates. Example 14 is a modification of Example 13 where the paraffin was replaced with a low VA content EVA to attempt to improve adhesion. Example 15 is an adhesive typical of what would be used for labeling applications involving plastic films and bottles. Example 16 is another adhesive typical of what would be used for bonding wax coated board stock. None of these materials achieve the binding needed in this application. Example 17 having the SBC, the ethylene copolymer and the compatible tackifier only has the needed bonding characteristics.

TABLE 4
Bill we need to characterize these materials in Table 4
Raw Materials

| | |
|---|---|
| Tackifier | |
| Sylvalite RE-100L | (PE ester of wood rosin) |
| Sylvalite RE-85L | (Glycerol ester of wood rosin) |
| Wingtack Plus | (C-5 hydrocarbon tackifier) |
| Nyplast 222B | (Napthenic process oil) |
| Escorez 5400 | (Hydrogenated DCPD tackifier) |
| Norsolene A-110 | (C5/C9 tackifier) |
| Ethylene Vinylacetate | |
| AC-400 | (14% VA high MI EVA) |
| AC-405T | (6% VA high MI EVA) |
| AC-629 | (Oxidized PE wax) |
| EVA 33-43 | (33% VA 43 MI EVA) |
| EVA 28-400 | (28% 400 high MI EVA) |
| EVA-28-800 | (28% 800 high MI EVA) |
| EVA 20-2500 | (14% 2500 high MI EVA) |
| Polyolefin | |
| Affinity GA 1950 | (Low density polyethylene |
| | plastomer density .874 MI 500) |
| Ethylene/ | |
| Acrylic | |
| Enable 33-900 | (Ethylene N-butylacrylate copolymer) |
| Lotryl 37EH-550 | (Ethylene 2-ethylhexyl acrylate |
| | copolymer 37% EH, MI 550) |
| Elvaloy HP-771 | (Ethylene N-butylacrylate |
| | Carbon monoxide terpolymer) |
| AC-5120 | (Ethylene acrylic acid copolymer) |
| Styrene Block Copolymer | |
| Kraton D-1118 | (SBS 33% styrene, 78% di-block) |
| Kraton D-1102 | (SBS 28% styrene, 17% di-block) |
| Kraton G-1652 | (SEBS 30% styrene, 0% di-block) |
| Vector 8508 | (SBS 29% styrene, 0% di-block) |
| Globalprene 3520 | (SBS 31% styrene, 75% di-block) |
| Kraton 1119 | (SIS 22% styrene, 66% di-block) |
| Septon 2063 | (SEEPS 13% styrene, 0% di-block) |
| Wax | |
| Nat 155 | (155° F. MP hydrogenated soywax) |
| 155 Paraffin | (155° F. MP paraffin wax) |
| Paraflint C-80 | (80° C. MP fisher tropsch wax) |
| Antioxidant | |
| Benox 1010 | (Hindered phenol stabilizer) |

These data show that to successfully adhere a substrate to a coated paperboard, at room temperature (about 22-25° C.), at about 40° F. (4° C.) or at −10° F. (−25° C.), adhesive requires a ethylene copolymer, an SBC such as an SBS copolymer and a compatible tackifier such as a rosin esrter material. On useful adhesive comprises about 5 to 50 wt. % of an ethylene vinylacetate copolymer; about 5 to 35 wt. % of a styrene block SBS copolymer; and about 25 to 55 wt. % of a rosin ester tackifyer compatible with both the ethylene vinylacetate and the styrene butadiene copolymer. Such an adhesive can also contain about 5 to 30 wt. % of a compatible wax or wax/oil combination.

The composition of the present invention is preferably made by first preparing the thermoplastic component by melting and blending all the thermoplastic ingredients. The thermoplastic composition may be pelletized, pillowed, or cast into molds or drums, etc., for subsequent remelting and application. Alternatively, all the ingredients may be fed simultaneously at the appropriate rates into an extruder. In such compositions, the EVA polymer is typically present in an amount of about 5 to 50. In such compositions, the SBC polymer is typically present in an amount of about 5 to about 35 wt %. The polymer or polymer blends of the invention are combined with tackifying agent in an amount that ranges from about 25 to 55 wt % of the tackifying resin, often 30 to 50 wt % of the tackifying resin and in many embodiments of the invention about 35 to 45 wt % of the tackifying resin. The polymer or polymer blends of the invention are combined with wax in an amount that ranges from about 5 to 30 wt %, often 10 to 25 wt % and in many embodiments of the invention about 15 to 20 wt %. Typically, in the adhesives of this invention, the weight ratio of the EVA polymer or polymer blend to the SBC is about 1 to 3.

The amount of adhesive applied to the coated paperboard can vary depending on the size of the container being produced. Most of the add on applications use a Nordson ProBlue applicator which extrude the adhesive out of an 0.018 to about a 0.030 inch diameter nozzle onto the corrugated carton during the erection of the box or container at an add on amount of about 0.01 to 0.5 grams-lineal inch⁻¹ or 0.025 to 0.1 grams-lineal inch⁻¹.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of preferred embodiments herein, but instead by reference to claims attached hereto. Reference to a single element in the claims is intended not exclude one or more of the same element. The above specification, examples and data provide a complete description of the manufacture and use of the composition of the invention. The invention resides in the claims hereinafter appended.

We claim:

1. An paperboard assembly comprising:
(i) paper stock comprising a polymer coating on at least one surface;
(ii) a substrate layer; and
(iii) an adhesive bond joining the coating on at least one side of the stock to the substrate layer, the adhesive comprising about 5 to 50 wt. % of an ethylene copolymer; about 5 to 35 wt. % of a styrene block copolymer; about 25 to 55 wt. % of a tackifyer compatible with both the ethylene copolymer and the styrene butadiene copolymer; and about 5 to 30 wt. % of a compatible wax or wax/oil combination wherein the adhesive forms a bond to the coating sufficient to assemble a case or carton or to adhere a substrate to the coated layer.

2. The assembly of claim 1 wherein the assembly can be used at temperatures less than 4° C. without bond failure.

3. The assembly of claim 1 wherein the adhesive is used at about 0.025 to 0.1 grams-lineal inch⁻¹.

4. The assembly of claim 1 wherein the polymer coating comprises a polyester coating the assembly can be used without failure at temperatures less than −20° C. without bond failure.

5. The assembly of claim 2 wherein the polyester coating comprises a polylactic acid or a polyhydroxy butyrate and the stock comprises a coated paperboard stock or a coated corrugated paperboard stock.

6. The assembly of claim 1 wherein the substrate comprises a label.

7. The assembly of claim 1 wherein the substrate comprises a coated stock or coated paperboard stock.

8. The substrate of claim 5 wherein the adhesive is used to bond one portion of a coated paperboard stock to a second portion of the same corrugated paperboard stock.

9. The assembly of claim 1 wherein the adhesive comprises an ethylene copolymer comprises an ethylene vinyl aceteate copolymer comprising a melt index of about 100 to about 2500 grams-10 seconds⁻¹ and about 14 to about 30 wt. % of vinylacetate and a hydrogenated soy wax with a melting point of about 130 to 170° F.

10. The assembly of claim 1 wherein the styrene block copolymer comprises a styrene butadiene styrene block copolymer having about 10 to about 40 wt. % styrene and a molecular weight of about less than 200,000.

11. The assembly of claim 1 wherein the styrene block copolymer comprises a SBS block copolymer having about 30% styrene and a molecular weight of about less than 200,000.

12. The assembly of claim 1 wherein the paperboard stock having a polymer coating comprises a single polymer coating on one surface of the stock.

13. The assembly of claim 1 wherein the paperboard stock having a single polymer coating comprises a polymer coating on both surfaces of the stock.

14. An adhesive composition comprising about 5 to 50 wt. % of an ethylene copolymer; about 5 to 35 wt. % of a styrene block copolymer; about 25 to 55 wt. % of a rosin ester tackifier compatible with both the ethylene copolymer and the styrene butadiene copolymer; and about 5 to 30 wt. % of a compatible wax or wax/oil combination wherein the adhesive can form a bond to a coated paperboard sufficient to assemble a case or carton or to adhere a substrate to the coated layer at a temperature of less than about 4° C.

15. The composition of claim 14 wherein the ethylene vinylaceteate comprises a polymer having a melt index of about 100 to about 2500 grams-seconds⁻¹ and about 14 to about 30 wt. % of vinylacetate.

16. The composition of claim 14 wherein the styrene block copolymer comprises a styrene butadiene styrene block copolymer having about 10 to about 40 wt. % styrene and a molecular weight of less than 200,000.

17. The composition of claim 14 wherein the styrene block copolymer comprises a styrene butadiene styrene block copolymer having about 30% styrene and a molecular weight of about less than 200,000.

18. The composition of claim 14 wherein the weight ratio of the ethylene copolymer to the SBC is about 1 to 3.

19. The composition of claim 14 wherein the compatible wax comprises an hydrogenated soy wax.

20. The composition of claim 14 wherein the tackifier comprises a rosin ester tackifier.

21. An adhesive composition comprising about 5 to 50 wt. % of an ethylene copolymer; about 5 to 35 wt. % of a styrene block copolymer; about 25 to 55 wt. % of a rosin ester tackifier compatible with both the ethylene copolymer and the styrene butadiene copolymer; and about 5 to 30 wt. % of a compatible wax or wax/oil combination wherein the adhesive can form a bond to a coated paperboard sufficient to assemble a case or carton or to adhere a substrate to the coated layer at a temperature of less than 4° C.

22. The composition of claim 21 wherein the ethylene copolymer comprises an ethylene vinylaceteate comprising a polymer having a melt index of about 10,000 to about 30,000 grams-seconds⁻¹ and about 10 to about 15 wt. % of vinylacetate.

23. The composition of claim 21 wherein the styrene block copolymer comprises a styrene butadiene styrene block copolymer having about 10 to about 40 wt. % styrene and a molecular weight of less than 200,000.

24. The composition of claim 21 wherein the styrene block copolymer comprises a styrene butadiene styrene block copolymer having about 30% styrene and a molecular weight of about less than 200,000.

25. The composition of claim 21 wherein the weight ratio of the ethylene copolymer to the SBC is about 1 to 3.

26. The composition of claim 21 wherein the compatible wax comprises an hydrogenated soy wax.

27. The composition of claim 21 wherein the tackifier comprises a rosin ester tackifier.
